(19) United States
(12) Patent Application Publication
(10) Pub. No.: US 2009/0315990 A1
(43) Pub. Date: Dec. 24, 2009

(54) APPARATUS FOR SURVEILLANCE CAMERA SYSTEM

(75) Inventor: Peter Simmons, Vancouver (CA)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/142,204

(22) Filed: Jun. 19, 2008

(51) Int. Cl. H04N 7/18

(52) U.S. Cl. 348/143; 348/E07.085

(57) ABSTRACT

The present invention relates to surveillance systems using closed circuit television surveillance cameras, and in particular, to an apparatus that reduces the amount of heat received by a sensor of a surveillance camera. The apparatus comprises a first enclosure containing a lens assembly, a sensor coupled to the lens assembly, and a processor coupled to the sensor for producing a video signal. The apparatus further comprises a second enclosure separate from the first enclosure. The second enclosure contains a camera control mechanism operable with the lens assembly and the sensor, and a power supply for supplying power to the first and second enclosures. The first and second enclosures are configured such that the lens assembly and the sensor are generally insulated from heat generated by the power supply and the camera control system.

### FIELD OF THE INVENTION

The present invention relates to surveillance camera systems using closed circuit television surveillance cameras, and in particular, to an apparatus that reduces the amount of heat received by a sensor of a surveillance camera.

### BACKGROUND OF THE INVENTION

Today, surveillance camera systems are commonly employed as a security measure. The cameras are normally used to generate a video image of an area under surveillance that is displayed to an/or recorded for use by security personnel. Traditional closed circuit television (CCTV) cameras for surveillance applications have been based on three design concepts. The first generation rectangular body camera style has all of the electronic circuitry inside the camera case, with an external lens and mounting hardware. This camera design is rather bulky and overt, in that the direction that the camera is pointing is very apparent. An extra weatherproof housing is required for outdoor applications, adding to the size, weight and cost of the solution. In an attempt to minimize the size of the outdoor surveillance camera, a bullet style camera with integrated mount and weatherproof housing was developed. The overall size is smaller than the more traditional, rectangular body style.

For more covert applications, and for better aesthetics with the surrounding environment, fixed minidome style surveillance cameras are used. With minidome surveillance cameras, the entire camera and associated components are housed within the dome (transparent or semi-transparent). This allows for a discreet camera operation, as it is more difficult to see where the lens is pointing.

However, all of these cameras have the electronic circuitry, typically a power supply, a camera sensor and a camera control system located within the same housing, usually within close proximity of each other.

Video performance of the camera sensor is affected by heat produced by the power supply and the camera control system, as well as by the ambient temperature of the environment. Additionally, electrical interference from other components reduces video integrity, which can lead to more expensive components and longer design times for cameras. Different camera sensors have different heat and electrical susceptibility characteristics, further complicating the design and testing cycles for the development of a family of cameras.

Additional electrical demand from integrated infrared LEDs on the surveillance camera can increase the heat generated by the power supply board, as well as heat from the LEDs themselves, further degrading the quality of the video.

Recent developments in camera design include the newer internet protocol (IP) cameras. These cameras include extra video compression boards to compress the video for transmission on an IT network. This extra power can be minimized through the use of application specific ICs (ASICs), but an extra 1 or 2 W of power is still required. This leads to larger camera sizes, which operate over reduced temperature ranges. The ASIC design precludes the use of reprogrammable digital signal processor (DSP) based processing boards to perform video analytics in the camera. Straight DSP based solutions are more power intensive than ASICs, leading to increased heat dissipation within the camera, which further degrades the video performance and/or limits the functionality of the camera in order to conserve power and reduce heat.

Therefore, what is needed in the art is an apparatus that separates the heat generating components of a surveillance camera from the camera sensor to enhance video performance.

### BRIEF SUMMARY OF THE INVENTION

In one exemplary embodiment, the invention is directed to an apparatus for a surveillance camera system comprising a first enclosure containing a lens assembly and a sensor coupled to the lens assembly, and a processor coupled to the sensor for producing a video signal. The system also comprises a second enclosure separate from the first enclosure. The second enclosure contains a camera control mechanism operable with the lens assembly and the sensor, and a power supply for supplying power to the first and second enclosures.

In one embodiment of the invention, the second enclosure further comprises an image processing system for receiving the video signal.

In another embodiment of the invention, the first enclosure is electrically coupled to the second enclosure for communicating video signal from the processor to the image processing system.

In another embodiment of the invention, the camera control mechanism includes an interactive display.

In another embodiment of the invention, the interactive display is controlled by one of a dual in-line package (DIP) switch and an Internet web browser.

In another embodiment of the invention, the sensor includes one of a charge coupled device (CCD) and a complementary metal-oxide-semiconductor (CMOS) device.

In another embodiment of the invention, the image processing system comprises a compression engine for compressing the video signal and an output device for outputting the video data to a network.

In another embodiment of the invention, the network is an Internet Protocol (IP) network.

In another embodiment of the invention, the image processing system further comprises a converter for converting the video signal from analog to digital.

In another embodiment of the invention, the lens assembly includes a lens and a lens controller for providing electromechanical adjustment of the lens.

In another embodiment of the invention, the second enclosure includes an opening therein to allow access to the power supply and the camera control system.

In another embodiment of the invention, the first enclosure is supported by a mounting mechanism.

In another embodiment of the invention, the mounting mechanism is coupled to the second enclosure.

In another exemplary embodiment, the present invention is directed to a surveillance system comprising a surveillance camera that includes a lens assembly, a sensor, and a processor housed within a first enclosure. The surveillance camera also includes a camera control mechanism and a power supply housed within a second enclosure separate from the first enclosure such that the lens assembly, the sensor, and the processor are generally insulated from heat generated within the second enclosure.

In another embodiment of the invention, the surveillance camera further includes an image processing system housed in the second enclosure for receiving the video signal.

In another embodiment of the invention, the surveillance system further comprises a heat sink coupled to the second enclosure.

In another embodiment of the invention, the surveillance system further comprises a central monitoring station coupled to the surveillance camera.

### BRIEF DESCRIPTION OF THE DRAWINGS

These and other objects, features and advantages of the present invention will become apparent from the following detailed description of illustrative embodiments where, which is to be read in connection with the accompanying drawings, in which:

FIG. 1 illustrates an orthogonal view of an apparatus for a surveillance camera system according to an embodiment of the present invention.

FIG. 2 illustrates a block diagram of the apparatus for a surveillance camera system shown in FIG. 1.

### DETAILED DESCRIPTION OF THE INVENTION

The present invention, which provides an apparatus that reduces the amount of heat received by a sensor of a surveillance camera, will now be described in greater detail by referring to the drawings that accompany the present application. It is noted that the drawings of the present application are provided for illustrative purposes and are thus not drawn to scale.

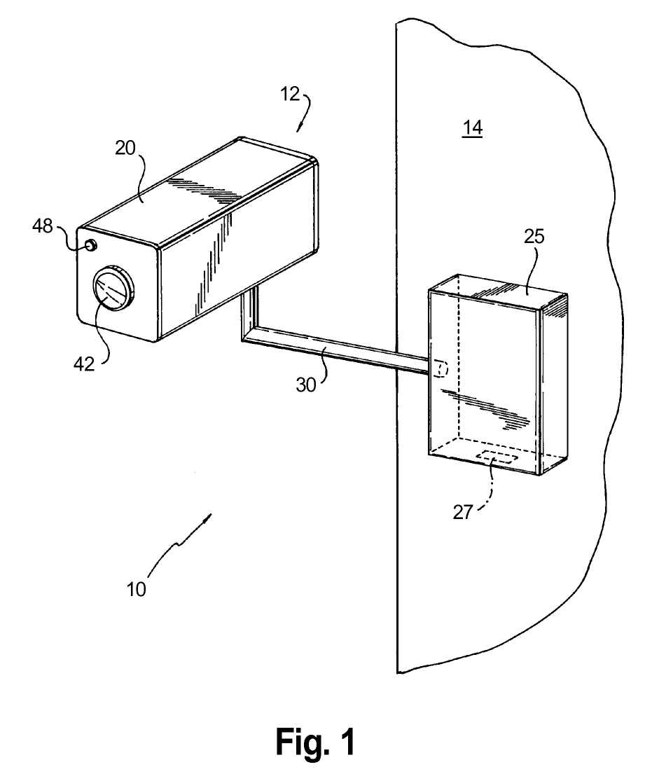

Aspects of the invention will be described first with reference to FIG. 1, which depicts an orthogonal view of an apparatus for a surveillance camera system (hereinafter “apparatus”) 10 according to the present invention. The apparatus 10 comprises two main enclosures for housing components of a surveillance camera that is mounted to a surface 14, such as a wall or ceiling in a selected area of interest. The apparatus 10 includes a first enclosure 20 and a second enclosure 25 separate from the first enclosure 20. As will be further described below, the first and second enclosures 20, 25 are configured such that common heat-generating components of the surveillance camera 12 are separated from the heat-sensitive camera components to improve video performance. In a preferred embodiment, the first and second enclosures 20, 25 may be formed of an injection-molded plastic such as, but not limited to, polystyrene, SAN, ABS, PPO, nylon, polypropylene (PP), polyethylene, PET, polycarbonates (PC), acrylics, K resin, and polyvinyl chloride (PVC), or other similar material.

As shown in FIG. 1, the mounting mechanism 30 is coupled to the second enclosure 25. The mounting mechanism 30 may be secured to the surface 14, or to any other suitable location for providing support to the first enclosure 20. The mounting mechanism 30 may be a single knuckle mount, as shown in FIG. 1, or have multiple knuckles. It can be appreciated that the mounting mechanism 30 can take on any number of different forms and can be coupled to the first enclosure 20 in any number of suitable ways for supporting the first enclosure 20. Furthermore, the mounting mechanism 30 houses wiring (not shown) used to electrically couple the first and second enclosures 20, 25. The wiring may be coupled to an internal or external surface of the mounting mechanism 30, or configured in any number of different ways to provide the communication and transfer of data between the first and second enclosures 20, 25.

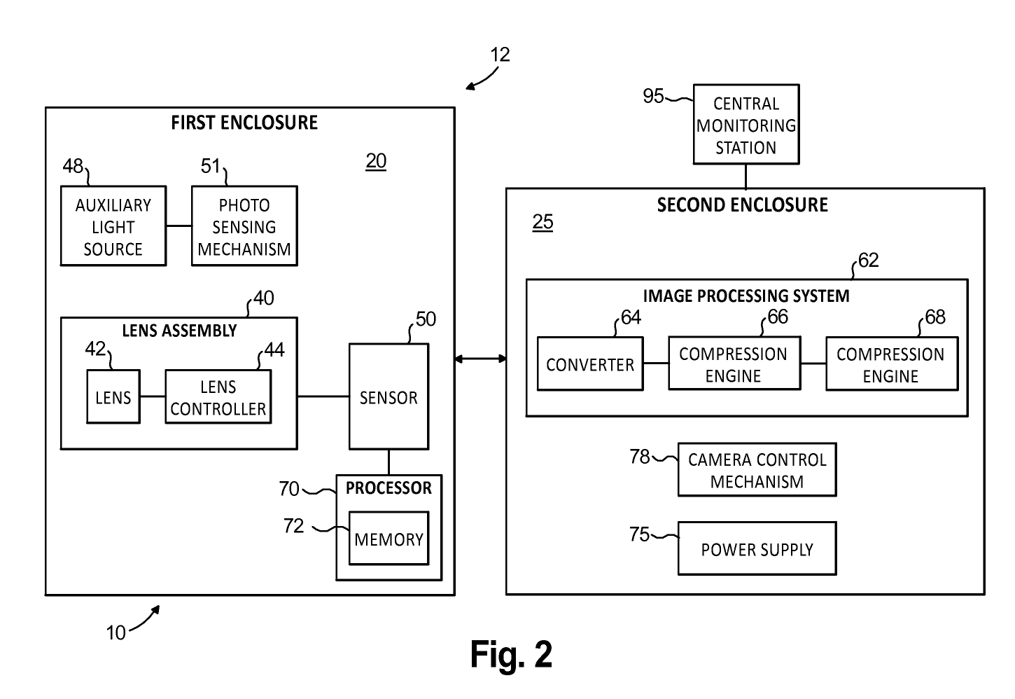

Referring now to FIG. 2, a block diagram of the apparatus 10 according to the present invention will be described in greater detail. As illustrated, the first enclosure 20 houses a portion of a surveillance camera 12, including a lens assembly 40, a sensor 50, and a processor 70. The lens assembly 40 includes a lens 42 and a lens controller 44 for providing electromechanical adjustment of the lens 42. In a preferred embodiment, the lens 42 is a varifocal lens having an automatic iris controlled by an exposure algorithm implemented by the sensor 50 and the processor 70. As is conventionally known, the lens controller 44 includes an auto iris circuit for further controlling the iris function of the lens 42.

The lens assembly 40 communicates data from the field of view to the sensor 50, which may be a charge coupled device (CCD) or complementary metal-oxide-semiconductor (CMOS) device. The sensor 50 may operate with a moving infrared (IR) cut filter for enhanced day/night operation. As is well known in the art, an optional auxiliary light source 48, such as an infrared LED, provides illumination for the lens 42 during low-light conditions. The auxiliary light source 48 is coupled to a photo sensing mechanism 51 to control the operation of the auxiliary light source 48 based on ambient light conditions.

The sensor 50 is coupled to the processor 70, which may be any one of a number of conventionally known digital signal processors capable of providing the control and data processing functions required by the lens assembly 40 and the sensor 50. The processor 70 operates with memory 72, which may be a non-volatile storage memory for storing images and/or video data received from the sensor 50. The memory device 72 can be used for storing programs that enable the lens assembly 40 to operate.

As shown in FIG. 2, the second enclosure 25 contains a camera control mechanism 78 operable with the lens assembly 40 and the sensor 50. In a preferred embodiment, the camera control mechanism 78 includes an interactive display (e.g., an onscreen display menu) controlled by any number of different mechanisms such as, but not limited to, a dual in-line package (DIP) switch, an Internet web browser accessible by an operator at a central monitoring station 95, or any other suitable control mechanism.

The second enclosure 25 further includes an image processing system 62 for receiving the video signal from the processor 70. In the exemplary embodiment shown in FIG. 2, the image processing system 62 includes a converter 64 for converting the video signal from analog to digital, and a compression engine 68 for compressing the video signal. The compression engine 68 compresses the video data received by the processor 70 according to attributes assigned to that particular video signal, including compression to a desired compression level. The video data is then transferred to an output device 68, which outputs the video data to any number of suitable networks for use. In one embodiment, the video data from output device 68 is received by the central monitoring station 95.

It can be appreciated that the image processing system 62 may comprise alternative component configurations based on the type of surveillance camera used. For example, in one embodiment employing an analog surveillance camera, the image processing system 62 includes the converter 64 and the output device, but no compression engine. In another embodiment using an IP surveillance camera, the sensor 50 and the processor 70 output a digital signal to the image processing circuit 62, which compresses the digital signal and outputs the signal to an IP network. In this embodiment, the camera sensor 50 has a digital output and the compression engine 66 has a digital input. This eliminates the need for an A/D converter.

The components of the first and second enclosures 20, 25 receive power from a power supply 75 located within the second enclosure 25. The power supply 75 includes any power conversion circuitry from 110 VAC to 12 VDC and lower, 24 VC to 12 VDC and lower, or power over Ethernet to 12 VDC and lower. The DC power supply 75 may incorporate an AC adapter, which plugs into a conventional AC outlet. However, it can be appreciated that power may be provided by any number of different power sources, such as a battery or solar cell, or combinations thereof which are small enough to fit in the second enclosure 25, and powerful enough to supply power to the components in the first and second enclosures 20, 25.

The image processing system 62 and the camera control mechanism 78 may be coupled to the central monitoring station 95, where the video and/or image signals are recorded and displayed on a monitor (not shown). The central monitoring station 95 can receive video data from the processor 70 and the image processing system 62 continuously, periodically as programmed, or upon event detection such as by motion detection, audio detection, contact closure or any other triggering event. Data from the output device 68 of the image processing system 62 may be sent wirelessly using a wireless LAN or WAN connection, such as the Internet. This permits the central monitoring station 95 to be connected to the image processing system 62 anywhere there is WAN access. Any combination of local (such as Intranet) and remote (such as Internet, frame relay, ISDN, DSL, ADSL, T-1, T-2, OC-3 connected and the like) monitoring stations can be employed. The image processing system 62 may also be hardwired (e.g., a fiber optic link or an unshielded twisted pair) to central monitoring station 95. It can be appreciated that any number of surveillance cameras can communicate with the central monitoring station 95.

With the configuration of the apparatus 10 as shown in the exemplary embodiment of FIGS. 1-2, the first and second enclosures 20, 25 are physically seperated from each other such that the lens assembly 40 and the sensor 50 are generally insulated from heat generated by the power supply 75, the image processing system 62, and the camera control mechanism 78. By seperating the first enclosure 20 from the second enclosure 25 using the mounting mechanism 30, the amount of electrical interference and heat received by the sensor 50 is reduced, thus improving video performance. A heat sink (surface 14) can be provided to further decrease the amount of heat received by the sensor 50. The heat sink 14 is coupled to the second enclosure 25 to provide a path for the heat generated by the power supply 75 and the components within the second enclosure 25.

Accordingly, the present invention provides an apparatus that separates the heat generating components of a surveillance camera from the camera sensor to enhance video performance. Furthermore, it can be appreciated that the apparatus can be made modular in concept such that the same first enclosure can be used with a variety of components contained within the second enclosure. As shown in FIG. 1, the second enclosure 25 includes an opening 27 therein to allow access to the power supply 75 and the camera control system 60 to interchange the components within the second enclosure 25.

While the present invention has been described in an illustrative manner, it should be understood that the terminology used is intended to be in a nature of words of description rather than of limitation. Furthermore, while the present invention has been described in terms of illustrative and alternate embodiments, it is to be appreciated that those skilled in the art will readily apply these teachings to other possible variations of the invention. For example, although only a single rectangular surveillance camera body style has been shown and described, it is understood that any number of surveillance camera body styles may be used without departing from the spirit or scope of the invention.

We claim:

1. An apparatus for a surveillance camera system, comprising:
a first enclosure comprising:
a lens assembly;
a sensor coupled to the lens assembly; and
a processor coupled to the sensor for producing a video signal;
and
a second enclosure separate from the first enclosure, the second enclosure comprising:
a camera control mechanism operable with the lens assembly and the sensor; and
a power supply for supplying power to the first and second enclosures.

2. The apparatus of claim 1, wherein the second enclosure further comprises an image processing system for receiving the video signal.

3. The apparatus of claim 1, wherein the camera control mechanism includes an interactive display.

4. The apparatus of claim 3, wherein the interactive display is controlled by one of a dual in-line package (DIP) switch and an Internet web browser.

5. The apparatus of claim 2, wherein the first enclosure is electrically coupled to the second enclosure for communicating the video signal from the processor to the image processing circuit.

6. The apparatus of claim 1, wherein the sensor includes one of a charge coupled device (CCD) and a complementary metal-oxide-semiconductor (CMOS) imaging device.

7. The apparatus of claim 2, wherein the image processing system comprises:
a compression engine for compressing the video signal; and
an output device for outputting the video data to a network.

8. The apparatus of claim 7, wherein the image processing system further comprises a converter for converting the video signal from analog to digital.

9. The apparatus of claim 1, wherein the lens assembly includes:
a lens; and
a lens controller for providing electro-mechanical adjustment of the lens.

10. The apparatus of claim 1, wherein the first enclosure is supported by a mounting mechanism.

11. The apparatus of claim 10, wherein the mounting mechanism is coupled to the second enclosure.

12. A surveillance system, comprising:
a surveillance camera, including:
a lens assembly, a sensor, and a processor housed within a first enclosure; and
a camera control mechanism and a power supply housed within a second enclosure separate from the first enclosure such that the lens assembly, the sensor, and the processor are generally insulated from heat generated within the second enclosure.

13. The system of claim 12, wherein the surveillance camera further includes an image processing system housed within the second enclosure for receiving the video signal.

14. The system of claim 12, further comprising a heat sink coupled to the second enclosure.

15. The system of claim 13, wherein the first enclosure is electrically coupled to the second enclosure for communicating a video signal from the processor to the image processing system.

16. The system of claim 12, wherein the camera control mechanism includes an interactive display controlled by one of a dual in-line package (DIP) switch and an Internet web browser.

17. The system of claim 13, wherein the image processing system comprises:
a converter for converting the video signal from analog to digital;
a compression engine for compressing the video signal; and
an output device for outputting the video data to an Internet Protocol (IP) network.

18. The system of claim 12, wherein the lens assembly includes:
a lens; and
a lens controller for providing electromechanical adjustment of the lens.

19. The system of claim 12, wherein the second enclosure includes an opening therein to allow access to the power supply and the camera control system.

20. The system of claim 12, wherein the first enclosure is supported by a mounting mechanism coupled to the second enclosure.
